(19) United States
(12) Patent Application Publication
(10) Pub. No.: US 2018/0204544 A1
(43) Pub. Date: Jul. 19, 2018

(54) APPARATUS AND METHOD FOR MUTING STRINGS

(71) Applicant: Ofer Webman, Tempe, AZ (US)

(72) Inventor: Ofer Webman, Tempe, AZ (US)

(21) Appl. No.: 15/874,854

(22) Filed: Jan. 18, 2018

Related U.S. Application Data
(60) Provisional application No. 62/447,905, filed on Jan. 18, 2017.

(51) Int. Cl. G10D 3/04; G10C 3/16

(52) U.S. Cl. CPC G10D 3/046; G10H 3/18; G10C 3/166

(57) ABSTRACT

A mute is positioned beneath the strings of a stringed instrument and adjusted to make contact with one or more of the instruments strings. In this manner, the mute may be used to selectively “dampen” or restrict the normal vibration of the strings and, consequently, the sound made by the strings. The end result is that the natural vibratory sounds associated with stringed instruments may be altered, using the mute to remove some or all of the natural frequencies, subharmonics, loudness and sustain associated with the vibration of the strings, essentially “deadening” the natural sound of the instrument. Additionally, in at least some preferred embodiments of the present invention, additional devices may be used to create and introduce new and enhanced sounds from the vibrations of the strings.

### BACKGROUND OF THE INVENTION

### 1. Field of the Invention

The present invention relates generally to the field of acoustics and more specifically relates to an apparatus and method for muting the strings of a musical instrument.

### 2. Background Art

Music and musical instruments are an important part of most societies and stringed instruments, such as guitars, are popular throughout the world. Many variations of musical instruments exist, both acoustic and electrical, in many forms, shapes, and sizes. Often, depending on the venue and the style of the music, different types of sounds and sound effects may be desired in order to present the music to the audience in the most artistic fashion. In many cases, the sound level of an instrument will be boosted by the use of electronic devices such as amplifiers and speakers. This is especially the case for acoustical instruments when the acoustical instrument is being used in conjunction with electric instruments and when acoustical instruments are being played in venues that require some form of amplification due to the size of the venue and/or the audience.

Additionally, instead of amplifying the sound of the stringed instrument a musician may wish to soften the sound of the stringed instrument. For example, many stringed instruments will produce unwanted sounds or “noise” when the strings are plucked, strummed, or otherwise activated by the musician. For a guitar, there are generally four sources of string noise, typically more prominent when playing electric than acoustic, and more noticeable with distortion or compression. These four sources are resonance, bad technique, “bends”, and vibrations from neighboring strings.

Resonance.

Some strings will resonate when particular notes are played. The usual way to stop this for guitar players is with a combination of right and left hand muting, e.g., placing the hand on the strings to mute them.

Bad Technique.

On certain occasions, the musician will accidently contact a string that is not meant to be contacted, causing unwanted noise. This can be cured by simply contacting only the appropriate strings.

Bends.

String bending is a basic guitar technique, used a lot in blues and rock but also found a bit in most other styles (except classical). The idea is to “bend” (push a string across or over the fingerboard with the fingers on the left hand) so that the string gets tighter and the pitch goes up. When done incorrectly, other strings may also vibrate, producing unwanted sounds.

Previous Note Sustain.

If a previously activated string (e.g., when a note is played on a different string) is not muted properly, the previous sound may “linger” and create a dissonant sound.

These unwanted sounds or “noise” can be addressed by many different techniques. For example, a musician may use one or more fingers of a hand to mute the previously activated string, thereby silencing the string. Mechanical devices may be attached to the strings, thereby restricting the vibration of the strings. Other techniques may also be employed. While all of these techniques may be used to mute strings on a stringed instrument, they can be difficult to execute and may not be suitable for all situations. Accordingly, without improvements in the current apparatus and methods for muting the strings of musical instruments, particularly guitars, violins, and other acoustic instruments, the ability to effectively and efficiently provide musicians with enhanced opportunities for creative expression will continue to be sub-optimal.

### BRIEF SUMMARY OF THE INVENTION

A mute is positioned beneath the strings of a stringed instrument and adjusted to make contact with one or more of the instruments strings. In this manner, the mute may be used to selectively “dampen” or restrict the normal vibration of the strings and, consequently, the sound made by the strings. The end result is that the natural vibratory sounds associated with stringed instruments such as a guitar are altered, using the mute to remove some or all of the natural frequencies, subharmonics, loudness and sustain associated with the vibration of the strings, essentially “deadening” the natural sound of the instrument. Additionally, in at least some preferred embodiments of the present invention, additional devices may be used to create new and enhanced sounds from the vibrations of the strings.

### BRIEF DESCRIPTION OF THE FIGURES

The preferred embodiments of the present invention will hereinafter be described in conjunction with the appended drawings, wherein like designations denote like elements, and:

FIG. 1 is a side view schematic representation of a device for muting strings in accordance with a preferred exemplary embodiment of the present invention;

FIG. 2 is a perspective view of a device for muting strings in accordance with an alternative preferred exemplary embodiment of the present invention;

FIG. 3 is a perspective view of a device for muting strings in accordance with an alternative preferred exemplary embodiment of the present invention;

FIG. 4 is side view of the device of FIG. 3 for muting strings in accordance with an alternative preferred exemplary embodiment of the present invention; and

FIG. 5 is a flow chart of a method used for muting strings in accordance with a preferred exemplary embodiment of the present invention.

### DETAILED DESCRIPTION OF THE INVENTION

A portable and repositionable string mute is positioned beneath the strings of a stringed instrument such as a guitar and used to engage the strings and thereby “dampen” the natural sound of the strings, by removing most of the natural frequencies, subharmonics, loudness and sustain, essentially “deadening” the natural sound of the strings of the instrument.

By dampening (e.g., “deadening”) the strings, the character of the stringed instrument is completely changed. The strings may still retain some of their timber and percussive qualities but will generally lose most of the high frequencies, subharmonics, loudness, and sustain associated with the natural sound of the string vibration. In fact, dampening will “strip-down” or remove most of the tonal components that makes the familiar sound of the instrument while “making space” for new ones.

One benefit of removing the original tonal components is to “make room” for new sound properties that can be used to enhance, augment, or replace the original tonal components, effectively creating entirely new instrument sounds. This will allow a musician to be more creative by offering a larger sound palette to work with a wider variety of sounds and effects.

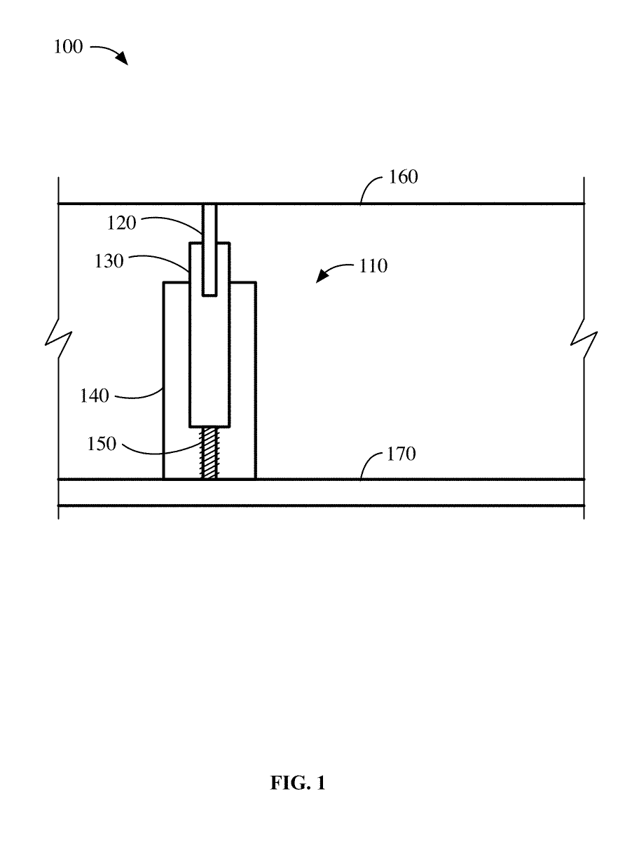

Referring now to FIG. 1, a block diagram 100 for deploying a mute 110 in accordance with a preferred exemplary embodiment of the present invention is depicted. As shown in FIG. 1, mute 110 is positioned between one or more strings 160 and the body of an instrument 170.

Mute 110 suitably comprises a mute body 140, a mute insert 130, an adjustment mechanism 150, and a mute material 120. These components work together to create a variable engagement with strings 160 to selective mute strings 160. Instrument 170 may be an acoustic guitar, an electric guitar, a violin, a piano, or any other instrument that has strings and where a musical sound is created by the vibration of strings 160.

For a guitar, mute 110 would be positioned beneath the strings of the guitar and close to the bridge, using the distance between the top of the soundboard and the strings for controlling the level of engagement for mute material 120 against strings 160.

In at least one preferred embodiment of the present invention, mute body 140 is attached to the body of instrument 170 via microscopic suction cups affixed to the bottom of mute body 140. In this fashion, mute body 140 will be held in place beneath strings 160 even without any tension being placed on strings 160 by mute material 120.

Mute material 120 may be any material suitable for muting strings 160. Depending on the desired effect, mute material may be a felt-like material, a metallic material, a foam-like material, a rubber material, etc. In the most preferred embodiments of the present invention, various types of mute material 120 may be selectively inserted into or removed from mute insert 130, thereby providing an opportunity to change the nature of the vibration of strings 160 based on the mute material 120 used.

Adjustment mechanism 150 comprises at least a threaded portion that can be rotated to increase or decrease the distance between mute material 120 and strings 160. At some level of extension, mute material 120 will contact strings 160 and provide a muting effect for the vibration of strings 160. At some level of retraction, mute material 120 will not contact strings 160 at all. In this fashion, the musician can selectively apply mute material 120 to the underside of strings 160 to control the vibration of strings 160 to achieve the desired effect.

In the most preferred embodiments of the present invention, adjustment mechanism 150 comprises two separate and independent adjustment mechanisms, with one on each end of mute 110. With this configuration, mute 110 may be adjusted so that mute material 120 contacts various strings 160 more directly in one location than another location. This can be useful for applying mute materials to some strings 160 while leaving other strings 160 free to vibrate naturally. Additionally, the amount of pressure applied to strings 160 can be controlled, thereby controlling the amount of vibration in strings 160.

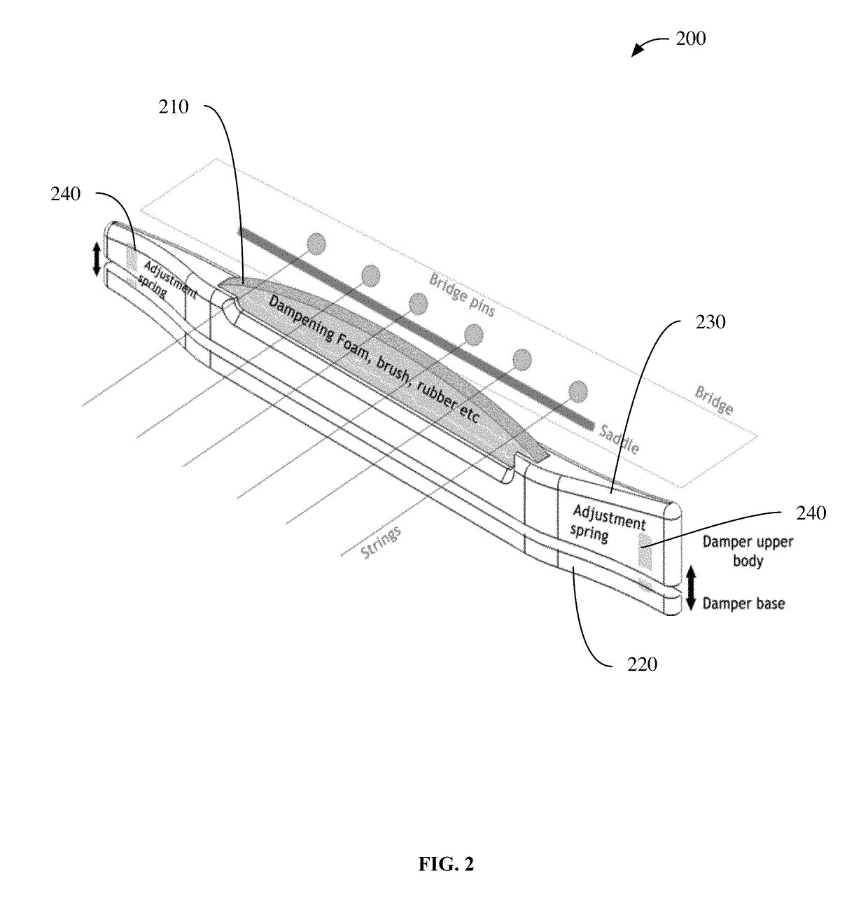

Referring now to FIG. 2, a schematic representation of a mute 200 for muting strings in accordance with an alternative preferred exemplary embodiment of the present invention is depicted. As shown in FIG. 2, mute 200 is positioned beneath the strings of a guitar, where it is “wedged” in place next to the bridge of the guitar, resting on the body of the guitar. In this embodiment, mute 200 is a three-piece mute. An upper body 230 and a lower body 220 are held together by a pair of springs 240. Muting material 210 is placed into upper body 230

Upper body 230 and lower body 230 may be manufactured from any suitable material including wood, plastic, etc. Considerations such as cost, aesthetics, durability, etc. will most likely guide the decision for manufacturing the components.

Muting material 210 is any material suitable for muting the strings of the instrument. For example, foam rubber, soft material, rubber, etc. may be used, depending on the amount of muting and the desired effect for the muted strings. A metallic material would tend to produce more of a metallic “hum” while foam would tend to complete deaden the string vibrations.

The ends of springs 240 are most preferably embedded into upper body 230 and lower body 230. This will connect upper body 230 and lower body 230. Springs 240 will be adjustable to allow for the variable spacing that may exist between the strings and the body of the guitar. Additionally, springs 240 will are configured to exert a pressure on upper body 230 and lower body 230, forcing them apart. This allows the distance between upper body 230 and lower body 230 to be automatically increased to fill the gap between the strings and the body of the guitar, thereby forcing muting material 210 into contact with the strings of the guitar. The exact amount of pressure exerted against the strings of the guitar may be adjusted by selectively changing the strength of springs 240, the length of springs 240, etc.

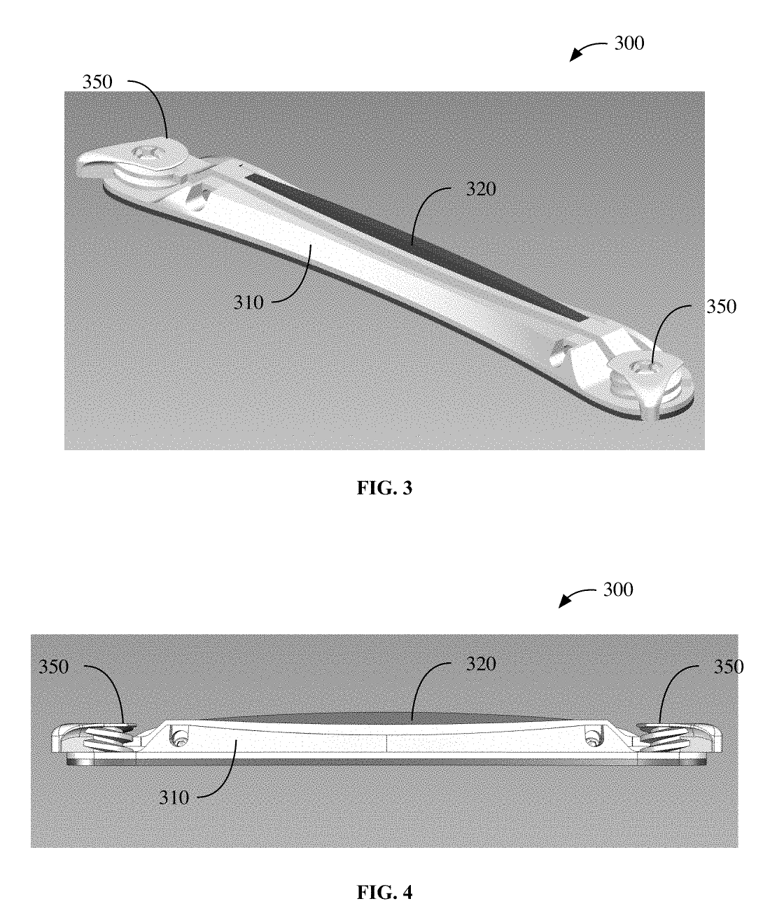

Referring now to FIG. 3 and FIG. 4, a schematic representation of a mute 300 for muting strings in accordance with an alternative preferred exemplary embodiment of the present invention is depicted. As shown in FIG. 3 and FIG. 4, mute 300 has an adjustment mechanism 350 positioned at each end of mute 300 that can be independently rotated clockwise or counter-clockwise to raise and lower mute material 320. Each adjustment mechanism has screw-like threads that engage mute body 310 to create vertical movement (e.g., up or down relative to the body of the instrument) of mute material 320.

As explained in conjunction with previous figures, mute 300 can be selectively positioned between the body of an instrument and the strings of the instrument and used to selectively engage one or more of the strings, thereby muting one or more of the strings to achieve the desired effect relative to controlling the vibrations of one or more of the strings. Once the need or desire to control the string vibration is over, mute 300 can be removed.

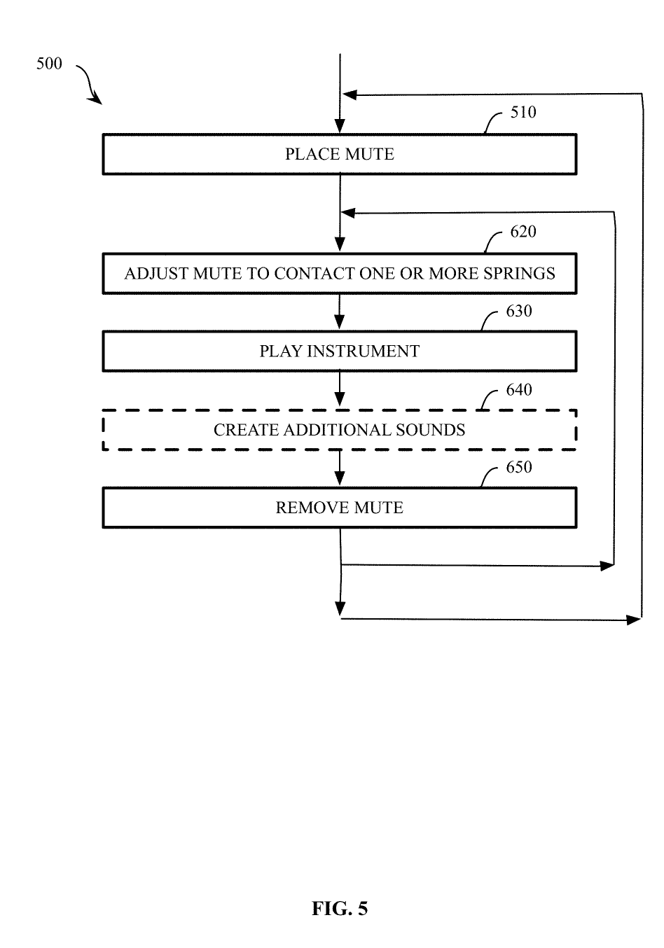

Referring now to FIG. 5, a flow chart for a method 500 for muting the strings of a stringed instrument is depicted. As shown in FIG. 5, the mute will be placed between the body of the instrument and the springs (step 510) and then adjusted to contact one or more of the strings (step 520). Once the mute has been positioned to contact one or more of the strings, the instrument can be played (step 630) and, optionally, another device can be used to create or augment sounds made by the strings (step 640). When completed, the mute can be removed (step 650) or the mute may be adjusted intermittently to achieve the desired sound.

As previously mentioned, with the strings effectively muted, an electronic device may be used in conjunction with the stringed instrument to create new frequencies and sub harmonics that are generated and used to “replace” these frequencies that are removed, essentially creating a new instrument with a completely different sound. One such device suitable for use with the most preferred embodiments of the present invention is the device taught in U.S. Pat. No. 9,111,517, the entirety of which is incorporated herein by reference.

1. A device for muting string vibration of a stringed instrument, the device comprising:
a mute body;
a mute material;
a mute material; and
an adjustment mechanism, the adjustment mechanism being configured to selectively alter a distance between the mute material and at least one instrument string of the stringed instrument.

2. The device of claim 1 wherein the device is positioned between an instrument body of the stringed instrument and the at least one instrument string so as to contact the at least one instrument string.

3. The device of claim 2 wherein the instrument body comprises one of a guitar body, a violin body, and a piano body.

4. The device of claim 1 wherein the device is positioned between an instrument body and the at least one instrument string so as to contact a plurality of instrument strings.

5. The device of claim 1 wherein the adjustment mechanism comprises a pair of threaded portions that can be rotated to increase or decrease the distance between the mute material and the at least one instrument string.

6. The device of claim 1 wherein the adjustment mechanism comprises a spring-loaded mechanism that is used to increase or decrease the distance between the mute material and the at least one instrument string.

7. The device of claim 1 wherein the stringed instrument comprises one of an acoustic guitar, an electric guitar, a violin, and a piano.

8. The device of claim 1 wherein the device is positioned to contact at least one but less than all of a plurality of strings.

9. The device of claim 1 wherein the mute material comprises at least one of a rubber material, a metallic material, a felt material, and a foam material.

10. The device of claim 1 further comprising an electronic device, the electronic device being configured to create or augment the sound of the stringed instrument.

11. A method comprising the steps of:
placing a mute between an instrument body and at least one instrument string;
adjusting the mute to contact the at least one instrument string; and
playing the instrument.

12. The method of claim 11 wherein the instrument body comprises one of a guitar body, a violin body, and a piano body.

13. The method of claim 11 further comprising the step of periodically adjusting the position of the mute while playing the instrument.

14. The method of claim 11 further comprising the step of periodically adjusting the mute so as to contact the at least one string with greater or lesser pressure.

15. The method of claim 11 wherein the step of adjusting the mute to contact the at least one instrument string comprises the step of adjusting the mute to contact a plurality of strings.

16. The method of claim 11 wherein the step of adjusting the mute to contact the at least one instrument string comprises the step of adjusting the mute to contact a first plurality of strings while simultaneously not contacting a second plurality of strings.

17. The method of claim 11 further comprising the step of using an electronic device to create or augment the sound of the instrument.

18. The method of claim 11 wherein the step of adjusting the mute to contact the at least one instrument string comprises the step of rotating a screw-like member to alter a distance between the mute and the at least one string.

19. The method of claim 11 wherein the mute comprises a mute material, the mute material being positioned to contact the at least one string.

20. The method of claim 19 wherein the mute material comprises at least one of a rubber material, a metallic material, a felt material, and a foam material.
